(19) United States
(12) Patent Application Publication
(10) Pub. No.: US 2013/0028538 A1
(43) Pub. Date: Jan. 31, 2013

(54) METHOD AND SYSTEM FOR IMAGE UPSCALING

(71) Applicants: Steven J. Simske, Fort Collins, CO (US); Dalong Li, Cypress, TX (US)

(72) Inventors: Steven J. Simske, Fort Collins, CO (US); Dalong Li, Cypress, TX (US)

(21) Appl. No.: 13/194,290

(22) Filed: Jul. 29, 2011

(51) Int. Cl. G06K 9/32

(52) U.S. Cl. 382/300; 382/299

(57) ABSTRACT

An embodiment provides a method for image upscaling. The method includes anti-aliasing an input image and downsampling the input image to create a lower resolution image. The method also includes interpolating the lower resolution image to obtain a higher resolution image and creating a filter map from the input image and the higher resolution image. The method also includes upsampling the input image using the filter map to create a high-resolution image.

### BACKGROUND

Super-resolution techniques can be used to estimate an image at higher resolution from low-resolution observations. It is very useful in many functional imaging applications, such as facial recognition. In multi-frame super-resolution techniques, multiple low-resolution images are provided. A high-resolution image is obtained by combining the non-redundant information in the low-resolution images. It normally involves image registration and image reconstruction steps.

A straightforward approach in image upscaling is interpolation. Using a low-resolution image, interpolation algorithms can be used to fill in the missing pixel values on a finer grid. However, the interpolated image is often blurry as a result of the interpolation methods, which assume that an image is smooth. For example, some higher frequency details may be missing from the interpolated image. A filter that enhances high-frequency information, such as a sharpening filter, may improve the quality of the image. However, although sharpened images may look sharper, there are usually artifacts in the images. In terms of peak signal-to-noise ratio (PSNR), the quality of the processed image may actually be degraded. Therefore, current image upscaling techniques fail to preserve the overall quality of an image.

### BRIEF DESCRIPTION OF THE DRAWINGS

Certain exemplary embodiments are described in the following detailed description and in reference to the drawings, in which:

FIG. 1 is a block diagram of a computer system in which input images are firstly interpolated and then filtered with appropriate self-trained or pre-trained enhancement filter coefficients to create high-resolution output images, in accordance with embodiments;

FIG. 2 is a process flow diagram showing a method to create an upsampled, high-resolution output image, in accordance with an embodiment;

FIGS. 3(A)-(E) show the result of using the current method to create a high-resolution version of an image, in accordance with an embodiment;

FIGS. 4(A)-(D) show the result of using the current method to create a high-resolution version of another image, in accordance with an embodiment;

FIG. 5 shows a simple compound image which is divided into different segments to be super-resolved separately according to the optimal interpolation method for each region, in accordance with an embodiment; and

FIG. 6 is a block diagram showing a tangible, computer-readable medium that stores code adapted to create a high-resolution output image, in accordance with embodiments.

### DETAILED DESCRIPTION OF SPECIFIC EMBODIMENTS

An embodiment described herein provides a system and method for upscaling an input image by self-training to obtain a higher resolution image. A self-trained enhancement filter requires a pair of images, including an input image, or ground-truth image, and a degraded version of the image. The degraded image may be formed by anti-aliasing the input image, downsampling the anti-aliased input image to reduce the size of the image, and upsampling the downsampled image using interpolation. As used herein, the terms “upsampling” and “downsampling” describe the process of increasing or decreasing the resolution or size of an image, respectively. From the pair of the images, we may learn an enhancement filter that maps the degraded image to the ground-truth image. The filter may be viewed as a high-frequency emphasizing filter since the degraded image is blurry, while the ground-truth image is less blurry. The underlying assumption behind the interpolation is that the image is smooth. However, due to the interpolation, the initial upsampled image is higher in resolution but still blurry. Therefore, the learned enhancement filter may allow for the recovery of the high-frequency details that were lost in the interpolation process. This filter is created by solving for the specific filter coefficients that produce the input image, or ground-truth, when convolved with the interpolated image. This filter may be viewed as a mapping function, which is then utilized to create a high-resolution or super-resolution image from the interpolation of the input image. As used herein, the term “filter” refers to a sharpening operator which may be used to enhance and restore the high-frequency components of an image.

In an embodiment, the input image is downsampled at the same ratio to be used in the super-resolution upsampling. Since the filter is learned from the interpolated image and the input image, the filter is adaptive to the interpolation method used. The filter maps may be learned by minimizing the errors between the upsampled image and the input image at different levels of the image pyramid. The optimal filter may be selected as the one which provides the least error between the upsampled image and input image in the self-training phase. Once a filter has been created for a particular interpolation method, the filter may be associated with a particular image class for all future operations for a specific up-scaling factor. In other words, the filter is determined by both the interpolation method and the up-scaling factor. As used herein, the term “image class” refers to the division of individual images into separate groups based on similarities. Each image class may be assigned to a particular filter map based on different interpolation methods optimized for each different image class or region of an image. Since different image classes require different interpolation methods, different filters may be used accordingly.

In an embodiment, the image class for a filter may be determined based on the type of image which provides the optimal outcome with that filter. For example, an image class for mug shots may utilize facial recognition techniques to identify the image as belonging to that class. In contrast, an image class for text may utilize optical character recognition techniques to identify the image as textual. The division of filters into different image classes reduces the number of filter coefficients stored by the computer, since the same filter map may be used for all the images within a particular class. Furthermore, different filters may be applied to different regions of a composite image based on the optimal interpolation method for each region.

In an embodiment, additional self-trained filters may also be trained on different levels of an image pyramid. As used herein, the term “image pyramid” refers to a type of multi-scale signal representation, in which an image is repeatedly smoothed, for example, by anti-aliasing, and subsampled as the image size is decreased. This may include downsizing the image by different ratios and retraining the filter on different levels. For example, the downsizing ratios may include ratios that are not power-of-two multiples of each other, allowing for multiple base frequencies. While filters may be learned from very small images, they may often be learned from larger images, since filters learned from smaller images tend to be less useful. For each learned filter, the error between the filtered image, or predicted output, and the input image, or ground-truth, may be computed. The error values for all of the learned filters may be compared, and the final filter is chosen based on which filter has the minimal prediction error. As an example, error values may be calculated using the mean-square error method to determine the magnitude of the differences between the predicted output image and ground-truth image.

One of the advantages of using this method may be the large reduction in computer storage space that is needed to super-resolve an image. According to this method, the system may only have to store the original input image, the filter, and the interpolation method used for the upscaling algorithm. The original input image may be stored in a compressed state in order to further decrease the storage space. In addition, the filter coefficients are not expected to occupy much storage space since a 5-by-5 filter has been shown to perform well. Thus, this corresponds to only a few tens of bytes of data storage. After compression, the space occupied by the coefficients may be considered negligible. Furthermore, many different filter sizes may be attempted in order to determine which size produces the best upscaling results, the best upscaling compression, or a weighted combination of these two.

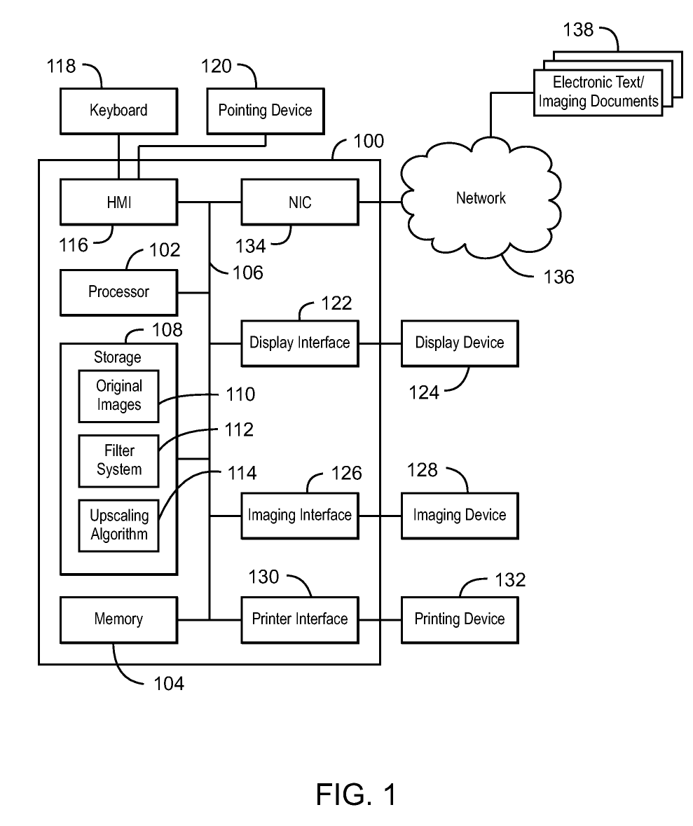

FIG. 1 is a block diagram of a computer system 100 in which input images are firstly interpolated and then filtered with appropriate self-trained or pre-trained enhancement filter coefficients to create high-resolution output images, in accordance with embodiments. The computer system 100 may include a processor 102 that is adapted to execute stored instructions, as well as a memory device 104 that stores instructions that are executable by the processor. The processor 102 can be a single core processor, a multi-core processor, a computing cluster, or any number of other configurations. The memory device 104 can include random access memory (RAM), read only memory (ROM), flash memory, or any other suitable memory systems. These instructions implement a method that includes creating a high-resolution image from a low-resolution image through the use of a self-trained filter. The input image is anti-aliased and downsampled to create a lower resolution image. The lower resolution image is interpolated to obtain a higher resolution image, and a self-trained filter is created from a comparison of the input image and the interpolated image. Then, the original input image is upsampled using the filter map to create a high resolution output image. The processor 102 is connected through a bus 106 to one or more input and output devices.

The computer system 100 may also include a storage device 108 adapted to store the original input images 110, filter maps 112, and upscaling algorithm 114. The storage device 108 can include a hard drive, an optical drive, a thumbdrive, an array of drives, or any combinations thereof. A human machine interface 116 within the computer system 100 may connect the system to a keyboard 118 and pointing device 120, wherein the pointing device 120 may include a mouse, trackball, touchpad, joy stick, pointing stick, stylus, or touchscreen, among others. The computer system 100 may be linked through the bus 106 to a display interface 122 adapted to connect the system 100 to a display device 124, wherein the display device 124 may include a computer monitor, camera, television, projector, or mobile device, among others.

The computer system 100 may also be connected to an imaging interface 126 adapted to connect the system to an imaging device 128. The imaging device 128 may include a camera, computer, scanner, mobile device, webcam, or any combination thereof. A printer interface 130 may also be connected to the computer system 100 through the bus 106 and adapted to connect the computer system 100 to a printing device 132, wherein the printing device 132 may include a liquid inkjet printer, solid ink printer, large-scale commercial printer, thermal printer, UV printer, or dye-sublimation printer, among others. A network interface controller 134 is adapted to connect the computer system 100 through the bus 106 to a network 136. Through the network 136, electronic text and imaging input documents 138 may be downloaded and stored within the computer's storage system 108.

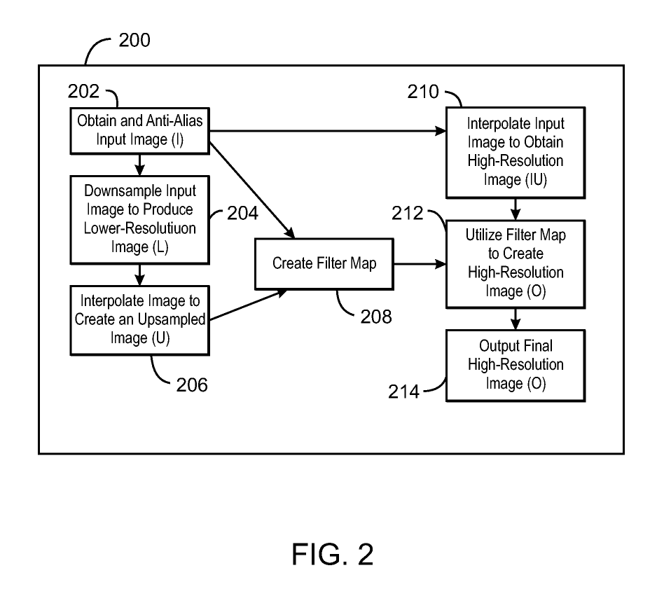

FIG. 2 is a process flow diagram 200 of a method for upscaling images. In the method, low-resolution input images are downsampled and upsampled by interpolation in the training phase to produce specific filter coefficients, which are then utilized to create an upsampled, high-resolution output image.

At block 202, an input image is obtained and the image is downsampled to reduce the image size. Anti-aliasing of the input image may be performed before the image is downsampled. The anti-aliasing may be performed using a bilinear method, Hermite method, cubic method, wavelet method or nearest neighbor method, or any combination thereof. The purpose of image anti-aliasing is to minimize the number of artifacts within the downsampled image by removing high-frequency components that may not be properly resolved at a lower resolution. As used herein, the term “artifact” refers to the distortion of an image resulting from lossy data compression. In context, any feature which appears in an image but was not present in the original input image may be considered an artifact. Artifacts often occur in data compression as a result of under-sampling high frequency data, such as window blinds, screens, and the like. The artifacts may resemble Moire patterns or other automatically identifiable artifacts. In many cases, pattern recognition techniques may be used to determine what types of artifacts have been induced in the image.

After anti-aliasing of the input image (I) 202, the image is downsampled at block 204 to reduce the size by discarding, averaging, or otherwise reducing the set of pixels in the image and thereby creating a low-resolution version of the input image (L). In one embodiment, an algorithm may be used to select which pixels to discard from the image. For example, if the image is to be downsized by a factor of 2, pixels may be discarded at rows/columns 1, 3, 5, 7, 9, etc. If the image is to be downsized by a factor of 3, pixels may be discarded at rows/columns 1, 4, 7, 10, 13, etc. However, in another embodiment, a stochastic method may also be used to discard pixels within a certain window to prevent halftone aliasing. The input image is downsized by the same factor as the image will be upsized to by super-resolution. This low-resolution image is utilized for the filter self-training system.

At block 206, the low-resolution version of the input image is interpolated to fill in the missing pixels, thereby increasing the size and resolution of the image to create an upsampled version of the image (U). The method used for interpolation may include the nearest-neighbor, linear, Kernel Regression, polynomial, bilinear, bicubic, B-spline kernels, or spline method, among others. For each image class, the best interpolation method is chosen based on the metric used for assessment of the image. These metrics may include peak signal-to-noise ratio, image entropy, image variance, user feedback, structural similarity index (SSIM), variance inflation factor, or p-norm, among others. As used herein, the term “p-norm” may refer to several different types of norms depending on the value of p, including Taxicab norm or Manhattan norm for p=1, Euclidean norm for p=2, or maximum norm for p=infinity, among others. Because interpolation methods inherently assume the smoothness of an image, the upsampled image may be blurry, even though it is super-resolved, since high-frequency details are missing from the image. As used herein, the term “smoothness” means that most of the energies are in low frequency bands in the frequency domain. While smoothness is a valid assumption which enables image compression, it may also cause the interpolated image to be blurry. In addition, smoothness may also be identified from measuring a number of other parameters.

In an embodiment, the peak signal-to-noise ratio (PSNR) may be used as a representation of the quality of a signal or original image data after reconstruction. The noise in this case may be the error introduced into an image signal due to downsampling of the image. Therefore, the peak signal-to-noise ratio may represent the ratio of the maximum amount of original data that may be recovered from a downsampled image versus the amount of noise that affects the fidelity of the image data. Mathematically, the peak signal-to-noise ratio is defined as shown in Eqn. 1.

$$PSNR ( \hat{f} ) = 10 {log}_{10} \frac{{\sum }_{i = 1}^{M} {\sum }_{j = 1}^{N} {255}^{2}}{{\sum }_{i = 1}^{M} {\sum }_{j = 1}^{N} {( f ( i , j ) - \hat{f} ( i , j ) )}^{2}} \qquad Eqn . 1$$

In Eqn. 1, \hat{f}(i, j) is the super-resolved image, and f (i, j) is the original high-resolution image. The size of the images is M-by-N.

The use of fixed high-frequency emphasizing filters may result in the presence of artifacts in the image despite an increase in sharpness. Types of image artifacts which may appear in the image include ringing, contouring, posterizing, aliasing, Moiré patterning, and staircase noise along curving edges, among others. Therefore, the self-trained high-frequency emphasizing filter (f) may be learned from the input image itself at block 208. The self-training technique relies on a comparison of the interpolated image and the original input image. An optimal filter may be found between the input image and interpolated image by solving a convolution equation for the filter coefficient values as shown in Eqn. 2.

I=U*f Eqn. 2

In Eqn. 2, * denotes convolution.

After the filter map has been created, the original input image may be upsampled according to the same scale and interpolation method to create an upsampled high-resolution image (IU) at block 210. At block 212, the filter map is used to adjust pixels to the image in order to reduce the number of artifacts and increase the sharpness of the image. From this process, a final high-resolution or super-resolution image (O) is obtained. At block 214, the high-resolution or super-resolution image (O) is sent to an output device, wherein the output device may include a printing device or display device.

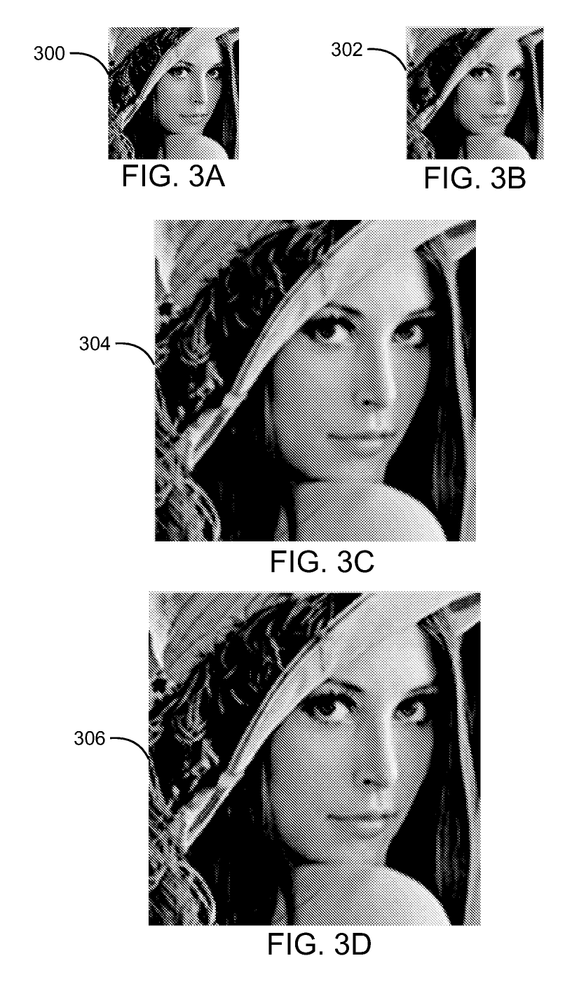

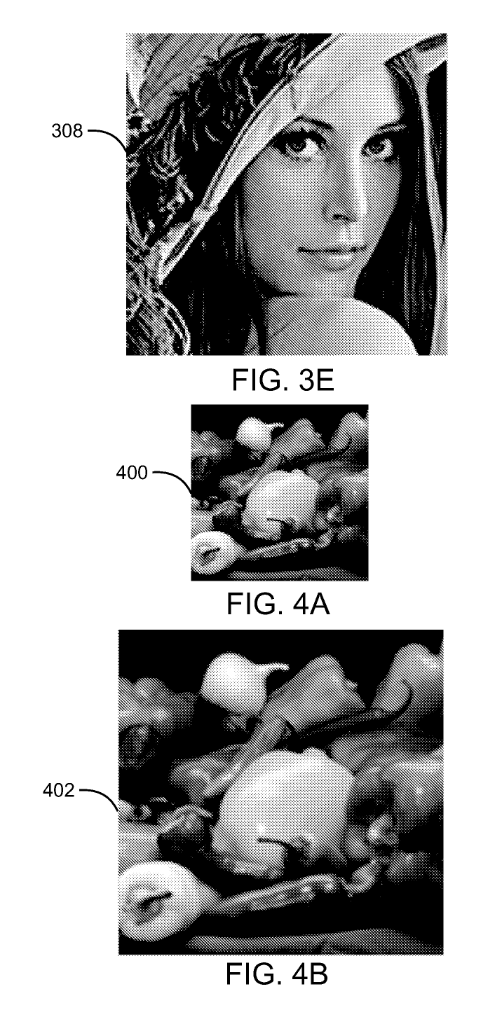

FIGS. 3(A)-(E) show an example of utilizing the current method to create a high-resolution version of the Lena image. For this example, the peak signal-to-noise ratio is used as the metric for assessment of the image. The Lena image is a standard test image that may be used for image processing algorithms. FIG. 3(A) shows the Lena image in its initial input state 300.

FIG. 3(B) shows the Lena image after downsampling and upsampling using an interpolation method 302. The interpolated image is created by filling in the missing pixels, using bicubic interpolation, in the downsampled image. The filter for the particular interpolation method may be learned during the self-training procedure from comparing the input image 300 and the interpolated image 302.

FIG. 3(C) shows an interpolated, upsampled version of the Lena image 304, which is created by using the same interpolation method to upsample the half-sized version of the original Lena image 300 to form the Lena image of FIG. 3(B). In this example, the interpolated image 304 has a PSNR of 31.3973.

FIG. 3(D) shows the super-resolved output version 306 of the Lena image created from using the 5-by-5 learned filter. The sharpness of the filtered image 306 in comparison to the raw interpolated image 304 is readily detectible. The PSNR of the filtered image 306 is 31.8306, which is a significant improvement over the PSNR of the interpolated image 304.

For comparison, FIG. 3(E) shows the output Lena image 308 obtained from filtering the image by a 3-by-3 unsharp masking filter for contrast enhancement, which is commonly used in commercial image processing software. The PSNR for this image 308 is 27.5507. Therefore, as compared to the example image created by the current method 306, the unsharpened image 308 has a significantly less favorable PSNR. As used herein, the term “unsharp masking filter” refers to a simple type of image filter that sharpens and enhances the edges of an image through a procedure which subtracts the unsharpened, smoothed version of the image from the original input image.

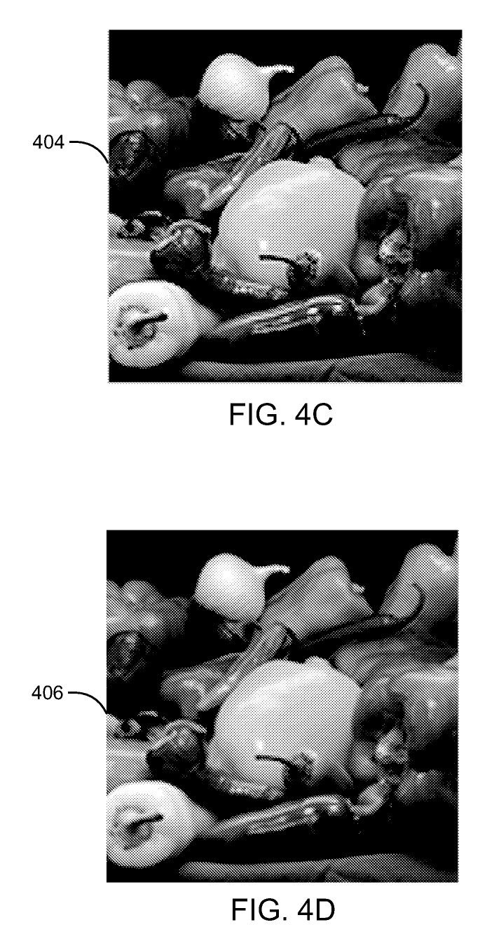

FIGS. 4(A)-(D) show an example of utilizing the current method to create a high-resolution version of a pepper image. For this example, the PSNR is used as the metric for assessment of the image. FIG. 4(A) shows the initial input version of the pepper image 400 that may be stored within the computer's storage system. This input image 400 may be downsampled to create a smaller, less-resolved version of the image.

FIG. 4(B) shows the interpolated version of the pepper image 402, which is created by interpolating the downsampled image to create an upsampled, interpolated version of the image 402. The PSNR for the interpolated image is 34.7445 in this example. The overall blurriness of the interpolated image 402 may result from the interpolation method due to the assumption of image smoothness. The self-trained filter may be created by solving a convolution function to determine the filter coefficients that produce the original input image 400 when convolved with the interpolated version 402 of the image. In this embodiment, a 5-by-5 filter is produced in the self-training process.

FIG. 4(C) shows an example of an unsharpened version 404 of the pepper image in order to illustrate the effectiveness of the current method in comparison to other methods for super-resolving images. The PSNR for the unsharpened image 404 is 31.166, which is significantly worse than the PSNR value for the interpolated image 402.

FIG. 4(D) shows the super-resolved output image 406 obtained by application of the self-trained 5-by-5 filter to the interpolated version of the input image. The PSNR for the final output image 406 is 35.0644, which is a significant improvement over the PSNR of the unsharpened image 404 and the interpolated image 402.

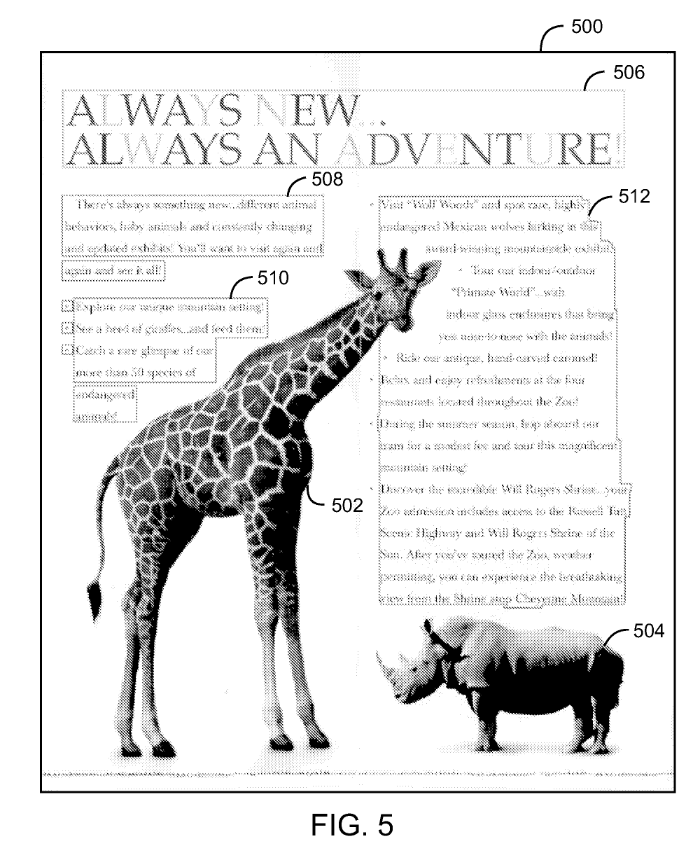

FIG. 5 shows an example of a compound image 500 that is divided into different segments to be super-resolved separately according to the optimal interpolation method for each region. This example shows the manner by which a filter may be associated with a particular image class. The image class for each filter may be determined based on the type of image which provides the best outcome with that filter. For example, FIG. 5 is divided into regions for different image classes. The giraffe 502 and rhinoceros 504 images are regions of the compound image that belong to an image class. In contrast, the text boxes 506, 508, 510, 512 are regions of the compound image that belong to a textual image class. The process of image classification may allow for greater accuracy for the upscaling of compound images while reducing the overall number of filter coefficients stored by the computer, since the same filter map may be used for many different images within a particular class.

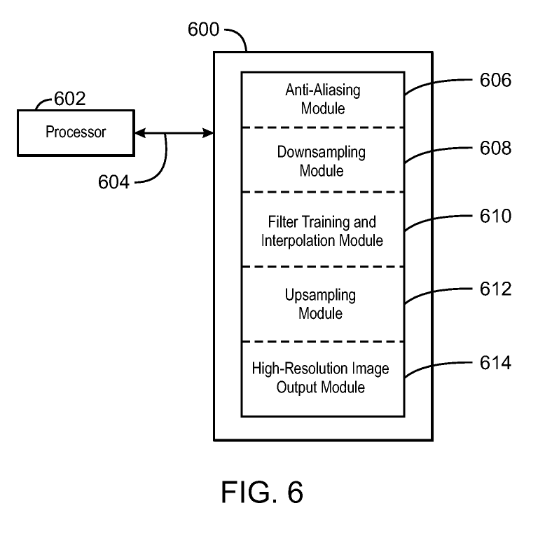

FIG. 6 is a block diagram showing a tangible, computer-readable medium 600 that stores code adapted to facilitate the anti-aliasing and downsampling of an image, filter training according to the optimal interpolation method for the appropriate image class, and upsampling of the image to create a high-resolution output image. The tangible, computer-readable medium 600 may be accessed by a processor 602 over a computer bus 604. Furthermore, the tangible, computer-readable medium 600 may include code configured to direct the processor 602 to perform the steps of the current method.

The various software components discussed herein may be stored on the tangible, computer-readable medium as indicated in FIG. 6. For example, an anti-aliasing module 606 may be stored in a first block on the tangible, computer-readable medium 600. A second block may include a downsampling module 608. A third block may include a filter training and interpolation module 610. A fourth block may include an upsampling module 612. Finally, a fifth block may include a high-resolution image output module 614. Embodiments are not limited to these arrangements, as any number of different combinations and arrangements may be used to perform the same functions.

In an embodiment, the anti-aliasing module 606 of FIG. 6 may be adapted to direct the processor to anti-alias the original input image before downsampling the image in the training phase. The anti-aliasing module 606 may perform the anti-aliasing procedure according to a bilinear method, Hermite method, cubic method, wavelet method or nearest neighbor method, among others. The anti-aliasing module 606 may function to minimize the number of artifacts within the downsampled image by removing high-frequency components that may not be properly resolved at a lower resolution.

In an embodiment, the downsampling module 608 of FIG. 6 may be adapted to direct the processor to downsample the anti-aliased input image by removing a certain number of pixels from the image. The size reduction of the image will be scaled according to the same ratio as the desired increase in size of the final highly-resolved image. The downsampling module 608 may produce a lower-resolution version of the original input image.

In an embodiment, the filter training and interpolation module 610 of FIG. 6 may be adapted to direct the processor to perform a filter self-training procedure to produce a filter map and set of coefficients to be stored by the computer system. The self-training procedure may include the interpolation of a downsampled version of the input image to produce an upsampled version of the image. Due to the inherent assumptions of the interpolation method, the image may be missing high-frequency details and appear to be blurry, despite the fact that it may be of higher resolution. Therefore, the self-training phase may include comparing the original input image to the interpolated image and training a filter by a convolution technique. Once the self-trained filter map and coefficients have been determined for a particular interpolation method, an appropriate image class may be assigned to that filter based on the optimal interpolation method for each type of images. Moreover, the computer system may store the filter map for future usage with similar images.

In an embodiment, the upsampling module 612 of FIG. 6 may be adapted to direct the processor to upsample the original image according to the same interpolation procedure performed for the filter training and interpolation module 610. Furthermore, the ratio of upsampling may be the same as the ratio of downsampling used in the downsampling module 608. This consistency may simplify the overall super-resolution procedure and allow for more accurate results. The upsampling module 612 may also include filtering the interpolated version of the input image through the self-trained filter in order to produce an optimal high-resolution or super-resolution image. The high-resolution image output module 614 may be adapted to direct the processor to output the final highly-resolved or super-resolved image to an output device.

In an embodiment, the current method and system of super-resolving images based on a self-training filter may also be utilized as a high-frequency emphasizing filter. In this embodiment, the self-training filter may perform more efficiently than a generic unsharp masking filter (UF) since it is an adaptive filter rather than a fixed filter. For each interpolation method utilized in the training phase, the self-training filter may learn a filter that is specific to that specific interpolation method. This may allow for a more robust calculation of the appropriate pixel placement during the image upsampling and super-resolving procedure.

### EXAMPLES

An embodiment of the current method was tested to determine the efficacy of the techniques. Several images were evaluated according to the current super-resolution by self-training method and system. In this embodiment, the upscaling ratio was set to be two, resulting in doubling the size of the images. For consistency, a bicubic interpolation method was utilized for all of the images. In addition to visual inspection of the results, PSNR and improvement in signal-to-noise ratio (ISNR) were used to evaluate the performance quantitatively. From PSNR, ISNR may be computed as shown in Eqn. 3.

ISNR=PSNR(\hat{f})−PSNR(g) Eqn. 3

In Eqn. 3, g is the interpolated image. Thus, the ISNR may reflect the improvement in terms of signal-to-noise ratio.

Table 1 lists the comparative results of a bicubic interpolation method, a bicubic interpolation and self-training filter (STF) method, and a bicubic interpolation and unsharp masking filter (UF) method. The image examples listed in Table 1 include the images presented in the aforementioned FIGS. 3 and 4, among others.

The results of Table 1 show that an interpolation and self-training filter method as discussed herein provides a better result than a standard interpolation and unsharp masking filter method. The mean change in signal to noise ratio according to the current method is 0.69, while the mean change in signal-to-noise ratio for the unsharp masking filter method is −1.70 according to this embodiment. Therefore, the current method resulted in an overall improvement in the signal-to-noise ratio, but the unsharp masking filter method did not.

TABLE 1
Comparative super-resolution results using a bi-cubic
interpolation method with a self-training filter (STF)
versus an unsharp masking filter (UF).

| | Interp | Interp + STF | Interp + UF |
|---|---|---|---|
| Image | PSNR | ISNR | ISNR |
| Baboon | 21.51 | 0.31 | −0.59 |
| Boat | 25.80 | 0.52 | −1.33 |
| Cameraman | 26.32 | 0.75 | −1.10 |
| Doc | 20.71 | 1.00 | −0.36 |
| House | 31.69 | 0.77 | −2.87 |
| Lena | 28.91 | 0.63 | −2.12 |
| Peppers | 29.63 | 0.64 | −2.26 |
| Tree | 27.59 | 0.92 | −2.93 |
| Mean | 26.52 | 0.69 | −1.70 |
| Stand. Dev. | 3.83 | 0.22 | 0.99 |

Table 2 lists the results when a Kernel Regression (KR) method is used as the interpolation method. The mean and standard deviation for each method are reported in the table also. In terms of PSNR/ISNR, the self-training filter method of the present embodiment provides the best results. The examples listed in Table 2 include the Lena image from FIG. 3 and the pepper image from FIG. 4, among others. The results show that the self-training filter method of the current embodiment may be more effective than the unsharp filter method because the mean ISNR is higher for the STF method.

TABLE 2
ISNR Comparative super-resolution results using a
Kernel Regression interpolation method with a self-training
filter (STF) versus an unsharp filter (UF)

| | KR | KR + STF | KR + UF |
|---|---|---|---|
| Image | ISNR | ISNR | ISNR |
| Baboon | −1.18 | −0.01 | −0.97 |
| Boat | −2.05 | −0.18 | −1.64 |
| cameraman | −1.94 | −0.25 | −1.66 |
| Doc | −1.87 | −0.20 | −1.22 |
| House | −3.29 | −0.01 | −3.07 |
| Lena | −2.81 | −0.11 | −2.12 |
| Peppers | −3.41 | −0.01 | −0.17 |
| Tree | −4.03 | −0.42 | −2.78 |
| Mean ISNR | −2.57 | −0.15 | −1.70 |
| Stand. Dev. | 0.96 | 0.14 | 0.95 |

As shown in the tables, the result of using interpolation and an unsharp masking filter may be negative in terms of ISNR, indicating that the processed images are degraded even though the images may look sharper. On the other hand, the proposed self-training filter method may increase the PSNR. The self-training filter method is fundamentally different from the unsharp filter method since the self-trained filter is a restoration filter, rather than a simple generic high-frequency emphasizing filter. While both the self-training filter method of the present embodiment and the unsharp masking filter method are high-frequency emphasizing filter methods, the self-training filter method is more effective because is it adaptive to the interpolation methods. While the results of the unsharp masking filter method may appear sharper, more artifacts may be observed in the image. In fact, the appearance of artifacts in the image is a common effect of over-sharpening.

What is claimed is:

1. A method for image upscaling, comprising:
anti-aliasing an input image;
downsampling the input image to create a lower resolution image;
interpolating the lower resolution image to obtain a higher resolution image;
creating a filter map from the input image and the higher resolution image; and
upsampling the input image using the filter map to create a high-resolution image.

2. The method of claim 1, comprising receiving the input image from a camera, computer, scanner, mobile device, webcam, or any combination thereof.

3. The method of claim 1, wherein anti-aliasing the input image comprises using a bilinear method, Hermite method, cubic method, wavelet method, or nearest neighbor method, or any combination thereof.

4. The method of claim 1, wherein interpolating the lower resolution image comprises using the nearest-neighbor, linear, bilinear, polynomial, Kernel Regression, bicubic, or spline method, or any combination thereof.

5. The method of claim 1, wherein creating a filter map comprises determining the optimal filter by comparing the input image to the upsampled image created by interpolation.

6. The method of claim 5, wherein comparing the input image to the upsampled image created by interpolation comprises solving for the filter coefficients that produce the input image when convolved with the upsampled image.

7. The method of claim 1, wherein upsampling the original input image using the filter map comprises creating a high-resolution image from a low-resolution image through the use of filter coefficients and interpolation methods.

8. The method of claim 1, comprising outputting an upsampled high-resolution image on a printer, monitor, camera, display device, or any combination thereof.

9. A system for image upscaling, comprising:
a processor that is adapted to execute stored instructions;
a storage device that is adapted to store information for the image upscaling system;
a memory device that stores instructions that are executable by the processor, the instructions comprising:
an anti-aliasing module configured to perform anti-aliasing of the original input image;
a downsampling module configured to create a lower resolution image from the input image by downsampling;
a filter training and interpolation module configured to determine an optimal filter by upsampling the lower resolution image by interpolation and comparison of the upsampled image with the original input image; and
an upsampling module configured to create a high-resolution image from the input image by interpolation using the appropriate filter coefficients and interpolation method.

10. The system of claim 9, wherein the computer system comprises a network interface controller adapted to obtain images from a network.

11. The system of claim 9, wherein the information stored on the storage device comprises the original input images, filter-training system, and upscaling algorithm.

12. The system of claim 11, wherein the filter-training system comprises compressed input images, a downsampling algorithm, interpolation methods, a convolution function, and specific filter coefficients.

13. The system of claim 9, wherein the anti-aliasing module comprises the use of the bilinear method, Hermite method, cubic method, wavelet method or nearest neighbor method, or any combination thereof.

14. The system of claim 9, wherein the downsampling module is configured to discard, average, or otherwise reduce the set of pixels in an image to create a downsized version of the image.

15. The system of claim 9, wherein the filter training and interpolation module comprises a self-training technique to obtain a filter map and set of filter coefficients by interpolating an image and minimizing the error between the convolved image and the input image to determine which filter coefficients convolved with the interpolated image may create the input image.

16. The system of claim 15, wherein an image may be divided into multiple regions or classes and interpolated according to the optimal method for each type of image class.

17. The system of claim 15, wherein the filter coefficients and interpolation method are tied to specific functional error metrics, comprising a variance inflation factor, structural similarity index, peak signal-to-noise ratio, p-norm or aesthetics, among others.

18. The system of claim 15, wherein the filter map is altered based on functional feedback, comprising image recognition accuracy, quality assurance, inspection, costumer preferences, or any combination thereof.

19. A tangible, computer-readable medium, comprising code configured to direct a processor to:
receive an input image from an input device;
perform a self-training technique on the input image to obtain a filter map by downsampling and upsampling the input image using an interpolation method;
obtain a high-resolution image from the input image using the filter map; and
output the final high-resolution image to an output device.

20. The tangible, computer-readable medium of claim 19, comprising code configured to direct the processor to solve a convolution function during the self-training technique to obtain filter coefficients.
